(19) United States
(12) Patent Application Publication
(10) Pub. No.: US 2024/0283203 A1
(43) Pub. Date: Aug. 22, 2024

(54) LOW PROFILE BOARD-TO-BOARD INTERFACE CONTACTORS

(71) Applicant: Molex, LLC, Lisle, IL (US)

(72) Inventors: Gino Stephen Antonini, New Fairfield, CT (US); Daniel Ardell White, Plainfield, IN (US); William E. Spink, JR., Zionsville, IN (US); James William Borrelli, JR., Watertown, CT (US); Bharath Dattatri Bharadwaj, Bengaluru (IN); Jean-Louis Mendes, Staffanstorp (SE); Kevin J. Tagan, Torrington, CT (US)

(21) Appl. No.: 18/438,529

(22) Filed: Feb. 12, 2024

Related U.S. Application Data
(60) Provisional application No. 63/446,194, filed on Feb. 16, 2023.
(60) Provisional application No. 63/455,424, filed on Mar. 29, 2023.

(51) Int. Cl. H01R 24/54; H01R 13/6585; H01R 24/68

(52) U.S. Cl. CPC H01R 24/542; H01R 13/6585; H01R 24/68

(57) ABSTRACT

Low profile board-to-board interface contactors are described. In one example, a board-to-board interface contactor includes a shield body housing, a shield lid over the shield body housing, an insulating interposer within the shield body housing, a press-biased conductive pin, and a compression member. The shield body housing includes a spring contact arm. The shield lid is positioned over the shield body housing and is seated upon the spring contact arm. The shield lid includes a central contactor opening through which the conductive pin can extend to facilitate electrical contact for the communication of a radio frequency signal. The insulating interposer is positioned within the shield body housing, with the press-biased conductive pin extending through an aperture in the insulating interposer. The compression member is positioned with the insulating interposer, under the press-biased conductive pin, and the compression member applies a compression bias against a bottom surface of the conductive pin.

### RELATED APPLICATIONS

This application claims priority to and the benefit of U.S. Provisional Patent Application No. 63/446,194 filed on Feb. 16, 2023 and U.S. Provisional Patent Application No. 63/455,424 filed on Mar. 29, 2023. The entireties of the disclosures of the provisional patent applications are incorporated herein by reference.

### BACKGROUND

Connectors, connector assemblies, and housings for connectors are important structural and functional components in many computing and data interconnect systems. A number of different types and styles of connectors are known and used to electrically transfer data and radio frequency signals among interconnected boards and systems. Board-to-board connectors are relied upon to electrically couple data signals, radio frequency signals, and power between various types of printed circuit boards and other electrical and electro-mechanical assemblies. With the continued increase in the number of features and capabilities of electronics and related devices, such as cellular phones, computers, tablets, and other devices, many devices now include several printed circuits boards and related assemblies in a common housing.

### SUMMARY

Low profile board-to-board interface contactors are described. In one example, a board-to-board interface contactor includes a shield body housing, a shield lid over the shield body housing, an insulating interposer within the shield body housing, a press-biased conductive pin, and a compression member. The shield body housing includes a spring contact arm. The shield lid is positioned over the shield body housing and is seated upon the spring contact arm. The shield lid includes a central contactor opening through which the conductive pin can extend to facilitate electrical contact for the communication of a radio frequency signal. The insulating interposer is positioned within the shield body housing, with the press-biased conductive pin extending through an aperture in the insulating interposer. The compression member is positioned with the insulating interposer, under the press-biased conductive pin, and the compression member applies a compression bias against a bottom surface of the conductive pin. The spring contact arm can extend up from the top edge of the shield body housing in one example. In other aspects, the spring contact arm includes a number of contact arm bends, and the shield lid is seated upon the contact arm bends of the spring contact arm. In other aspects, the spring contact arm includes a number of spring contact arms. The spring contact arms extend in a ring around the press-biased conductive pin, over the insulating interposer.

In other aspects, the shield lid further includes an interlock arm, the shield body housing includes an extension channel having a longitudinal axis that extends between the top edge and the bottom edge of the shield body housing, and the interlock arm is positioned within the extension channel of the shield body housing. In other aspects, the insulating interposer includes an interlock extension that extends beyond an outer cylindrical surface of the insulating interposer, the shield body housing includes an interlock aperture, and the interlock extension is positioned within the interlock aperture, to maintain the position of the insulating interposer within the shield body housing.

A board-to-board interface system is also described. The system includes an interface contactor and a button contactor. The system can also include a first printed circuit board and a second printed circuit board. The first printed circuit board, the interface contactor, the button contactor, and the second printed circuit board can be arranged in a stack, to electrically couple at least one signal from the first printed circuit board to the second printed circuit board through the interface contactor and the button contactor.

The interface contactor includes a shield body housing with a spring contact arm, an insulating interposer positioned within the shield body housing, and a conductive pin extending through an aperture in the insulating interposer. The button contactor includes an insulating button interposer, and a shield ring housing that extends around the insulating button interposer.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example board-to-board interface contactor according to various embodiments of the present disclosure.

FIG. 1B illustrates a first side view of the board-to-board interface contactor shown in FIG. 1A according to various embodiments of the present disclosure.

FIG. 1C illustrates a second side view of the board-to-board interface contactor shown in FIG. 1A according to various embodiments of the present disclosure.

FIG. 1D illustrates a top-down view of the board-to-board interface contactor shown in FIG. 1A according to various embodiments of the present disclosure.

FIG. 1E illustrates a bottom-up view of the board-to-board interface contactor shown in FIG. 1A according to various embodiments of the present disclosure.

FIG. 1F illustrates a perspective view of the shield lid of the board-to-board interface contactor shown in FIG. 1A according to various embodiments of the present disclosure.

FIG. 1G illustrates a perspective view of the shield body housing of the board-to-board interface contactor shown in FIG. 1A according to various embodiments of the present disclosure.

FIG. 1H illustrates a perspective view of the board-to-board interface contactor shown in FIG. 1A, with the shield lid omitted, according to various embodiments of the present disclosure.

FIG. 1I illustrates a perspective view of the press-biased conductive pin and the insulating interposer of the board-to-board interface contactor shown in FIG. 1A according to various embodiments of the present disclosure.

FIG. 1J illustrates a perspective view of the press-biased conductive pin and the compression member of the board-to-board interface contactor shown in FIG. 1A according to various embodiments of the present disclosure.

FIG. 1K illustrates a perspective view of the compression member of the board-to-board interface contactor shown in FIG. 1A according to various embodiments of the present disclosure.

FIG. 1L illustrates the cross-sectional view of the interface contactor designated A-A in FIG. 1A according to various embodiments of the present disclosure.

FIG. 2 illustrates an example of the interface contactor shown in FIG. 1A, placed between two printed circuit boards according to various embodiments of the present disclosure.

FIG. 3A illustrates a bottom-up perspective view of a button contactor according to various embodiments of the present disclosure.

FIG. 3B illustrates a top-down perspective view of the button contactor shown in FIG. 3A according to various embodiments of the present disclosure.

FIG. 4 illustrates an example of the interface contactor shown in FIG. 1A and the button contactor shown in FIG. 3A between two printed circuit boards according to various embodiments of the present disclosure.

FIG. 5A illustrates a perspective view of another example board-to-board interface contactor according to various embodiments of the present disclosure.

FIG. 5B illustrates a perspective view of the interposers and conductive pin of the board-to-board interface contactor shown in FIG. 5A according to various embodiments of the present disclosure.

FIG. 5C illustrates a perspective view of the conductive pin and the compression member of the board-to-board interface contactor shown in FIG. 5A with the shield body housing omitted from view according to various embodiments of the present disclosure.

FIG. 6A illustrates a perspective view of another example board-to-board interface contactor according to various embodiments of the present disclosure.

FIG. 6B illustrates a perspective view of the interposers and conductive pin of the board-to-board interface contactor shown in FIG. 6A according to various embodiments of the present disclosure.

FIG. 6C illustrates a perspective view of the conductive pin and the compression member of the board-to-board interface contactor shown in FIG. 6A with the shield body housing omitted from view according to various embodiments of the present disclosure.

FIG. 7A illustrates a perspective view of another example board-to-board interface contactor according to various embodiments of the present disclosure.

### DETAILED DESCRIPTION

Connectors, connector assemblies, and housings for connectors are important structural and functional components in many computing and data interconnect systems. A number of different types and styles of connectors are known and used to electrically transfer data and radio frequency (RF) signals among interconnected systems. Board-to-board connectors are relied upon to electrically couple data signals, RF signals, and power between various types of printed circuit boards (PCBs) and other electrical and electro-mechanical assemblies. With the continued miniaturization of electronics and related devices, such as cellular phones, computers, tablets, and other devices, engineers are working to package many different PCBs closely together in a common housing. One limitation for arranging PCBs into closer proximity with each other, however, is the size of the board-to-board and other connectors and contactors used to electrically communicate the data and RF signals among them.

In the context outlined above, a number of low profile board-to-board interface contactors are described. In one example, a board-to-board interface contactor includes a shield body housing, a shield lid over the shield body housing, an insulating interposer within the shield body housing, a press-biased conductive pin, and a compression member. The shield body housing includes a spring contact arm. The shield lid is positioned over the shield body housing and is seated upon the spring contact arm. The shield lid includes a central contactor opening through which the conductive pin can extend to facilitate electrical contact for the communication of a radio frequency signal. The insulating interposer is positioned within the shield body housing, with the press-biased conductive pin extending through an aperture in the insulating interposer. The compression member is positioned with the insulating interposer, under the press-biased conductive pin, and the compression member applies a compression bias against a bottom surface of the conductive pin.

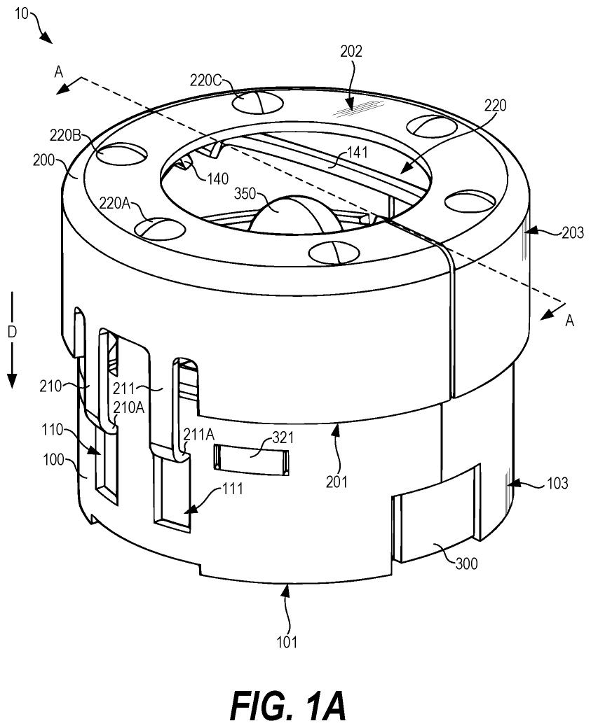

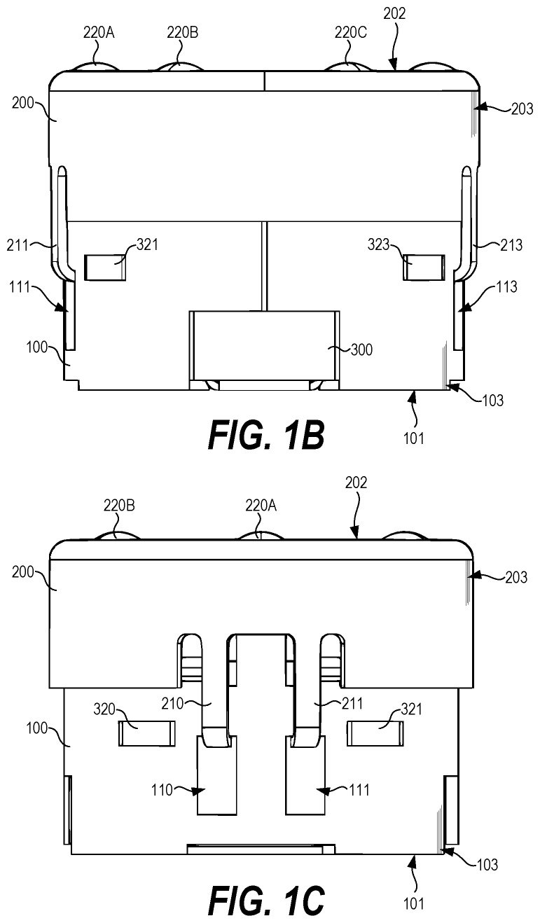

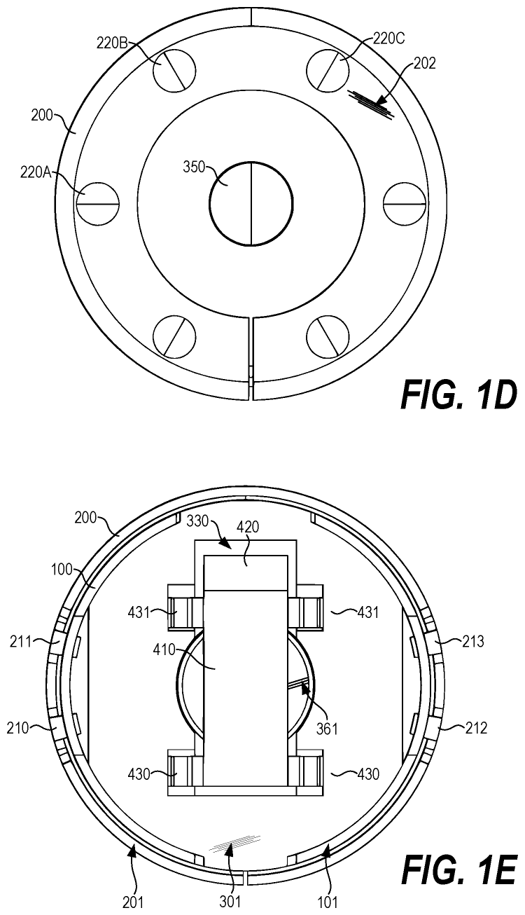

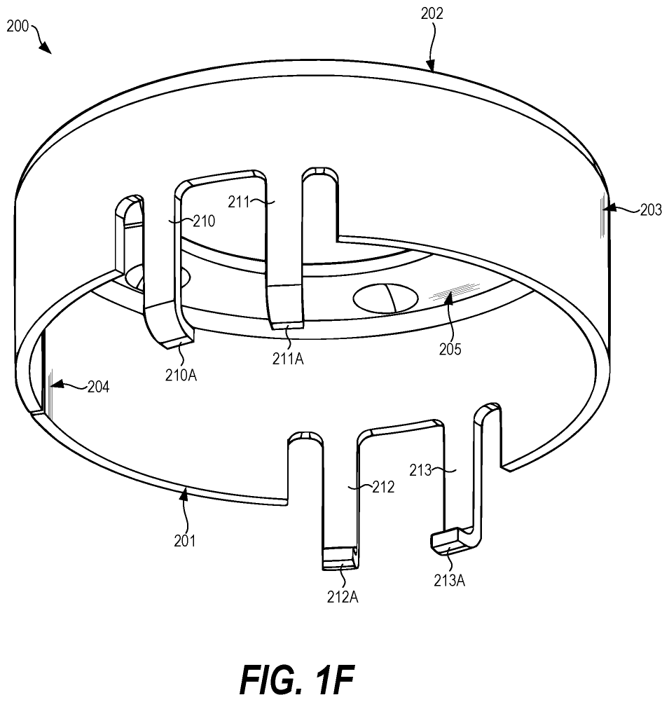

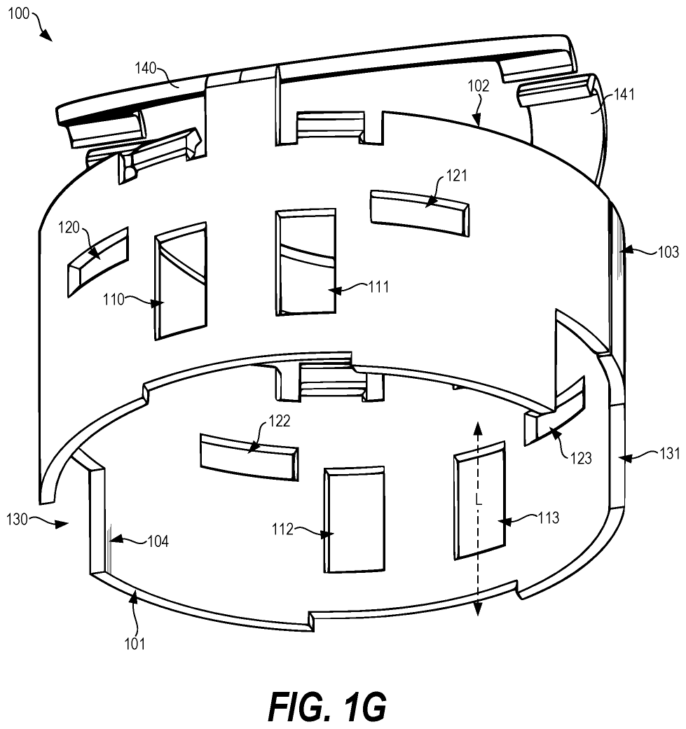

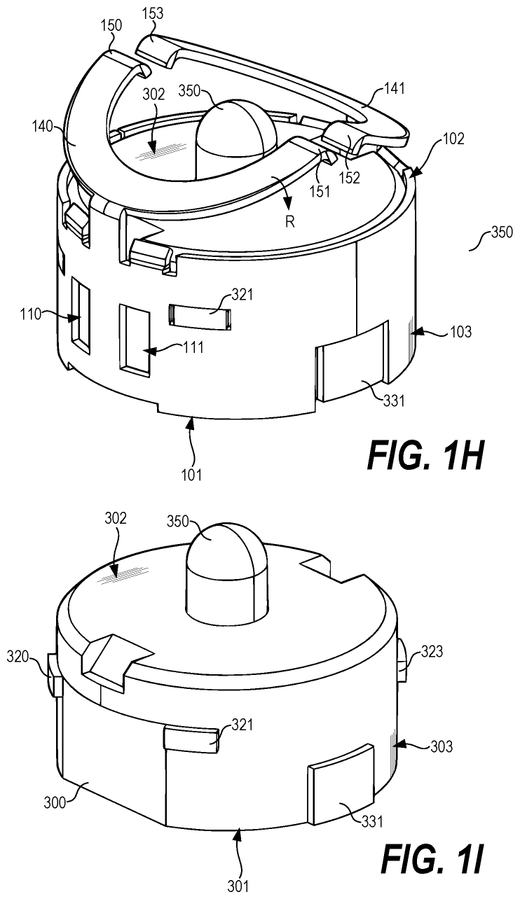

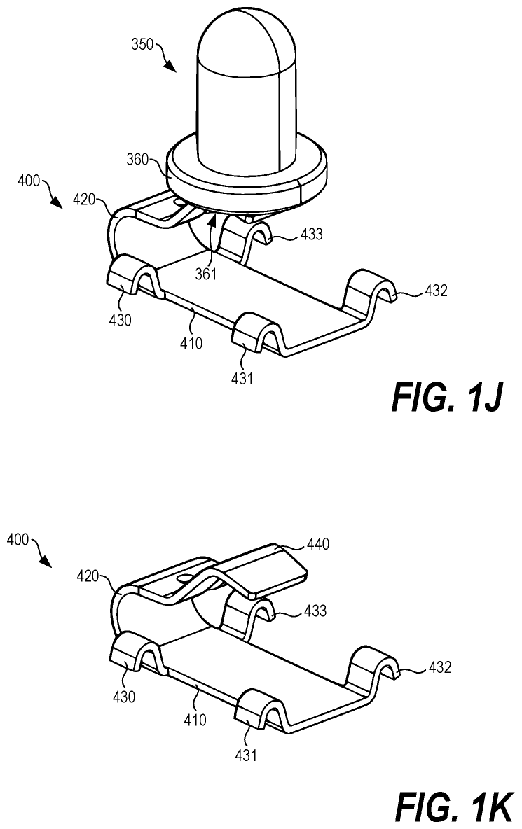

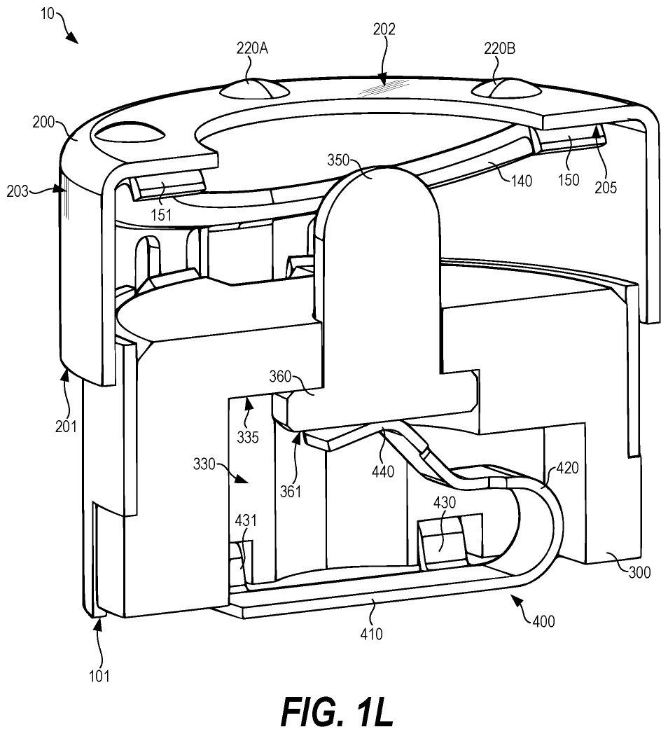

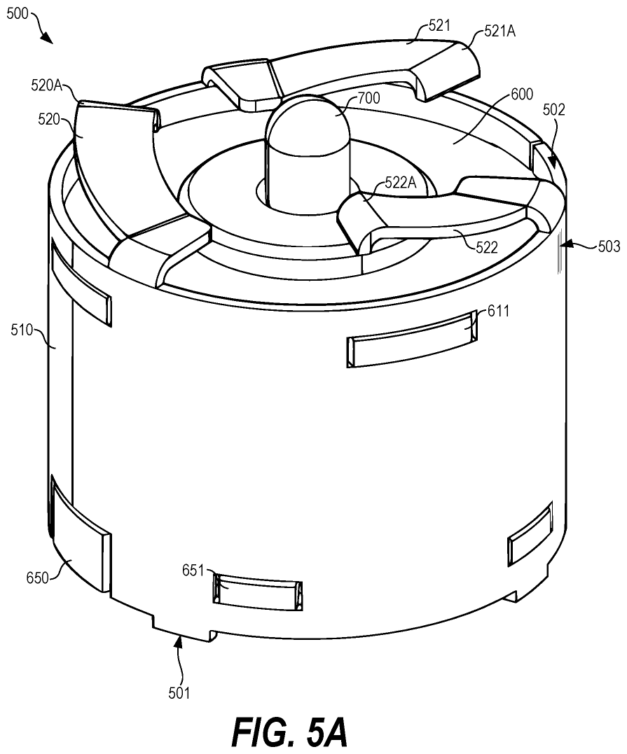

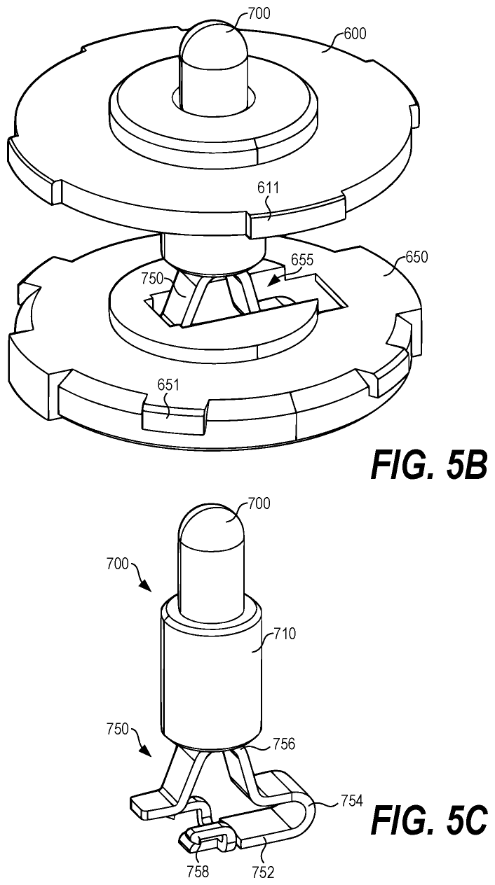

Turning to the drawings, FIG. 1A illustrates a perspective view of an example board-to-board interface contactor 10 (“interface contactor 10”) according to various embodiments of the present disclosure. Additionally, FIG. 1B illustrates a first side view, FIG. 1C illustrates a second side view, FIG. 1D illustrates a top-down view, and FIG. 1E illustrates a bottom-up view of the interface contactor 10 shown in FIG. 1A. The interface contactor 10 is representative, not drawn to any particular scale, and is illustrated to provide context for the concepts of the low profile board-to-board interface contactors or connectors described herein. The interface contactors described herein can be formed in a range of different shapes, styles, and sizes, although certain sizes and shapes are described and illustrated. Other types or styles of interface contactors are also described in further detail below with reference to FIGS. 5A-5C, 6A-6C, and 7A. The interface contactors described herein can be used in a range of interconnect applications, although board-to-board interface applications are described in some examples.

The interface contactor 10 can be relied upon as a type of low profile board-to-board interface contactor for electrically coupling an RF signal, for example, between two different PCBs, as described herein. The interface contactor 10 includes a shield body housing 100 (also “housing 100”) and a shield lid 200 (also “lid 200”). The shield body housing 100 includes a bottom edge 101, a top edge 102 (see FIGS. 1G and 1H), an outer surface 103, and an inner surface 104 (see FIG. 1G) among other edges and surfaces. The outer surface 103 is cylindrical in shape, in the example shown. The shield lid 200 includes a bottom edge 201, a top surface 202, an outer surface 203, an inner surface 204, and an under surface 205 (see FIG. 1F), among other edges and surfaces. The outer surface 203 is cylindrical in shape, in the example shown. The top surface 202 of the shield lid 200 includes a number of contact bumps, including contact bumps 220A-220C, among others. The contact bumps 220A-220C are raised bumps that extend up from the top surface 202. The contact bumps 220A-220C can be evenly spaced apart in a concentric arrangement as shown, although other spacings or placements of the contact bumps 220A-220C can be relied upon.

The shield lid 200 is concentrically positioned over and around the shield body housing 100, as shown in FIG. 1A, with the shield lid 200 being nominally larger than the shield body housing 100 to permit a clearance for movement between them. The lid 200 is arranged and interlocked over the housing 100 in a spring-biased arrangement, as described in further detail below. The lid 200 can be pushed down in the direction “D” against the spring bias. In that case, the lid 200 will cover more of the housing 100 than that shown in FIG. 1A, as the lid 200 will be pushed down further over the housing 100. Thus, the interface contactor 10 is compressible to some extent, as described herein.

The interface contactor 10 also includes an insulating interposer 300 (also “interposer 300”), which is positioned and secured within the shield body housing 100. The interface contactor 10 also includes a press-biased conductive pin 350 (also “conductive pin 350”). The conductive pin 350 is positioned within the interface contactor 10 between the shield body housing 100 and the shield lid 200. The conductive pin 350 is electrically isolated from both the housing 100 and the lid 200. The housing 100 and the lid 200 extend around the conductive pin 350, to help shield the conductive pin 350 from electromagnetic interference. When electrically coupled as a connector or contactor between PCBs, the housing 100 and the lid 200 can be electrically coupled to ground, common, or drain contacts on the PCBs, and the conductive pin 350 can be electrically coupled to RF or data signal traces or conductive pads on the PCBs.

The interface contactor 10 can be relied upon to electrically couple an RF signal between PCBs, in one example, although the interface contactor 10 can couple other types of signals, including data signals, between PCBs. To that end, the interface contactor 10 can be positioned between the planar surfaces of PCBs to form electrical couplings between them. In one example, the bottom edge 101 of the housing 100 can be mounted and electrically coupled (e.g., soldered, sintered, etc.) to conductive traces or pads of a first PCB, to form a common or drain coupling between the first PCB and the housing 100. An electrically-conductive compression member 400 (see FIGS. 1J and 1K and description below) of the interface contactor 10, which is electrically coupled to the conductive pin 350 within the interface contactor 10, can also be electrically coupled (e.g., soldered, sintered, etc.) to conductive traces or pads of the first PCB, to form electrical couplings between the first PCB and the conductive pin 350.

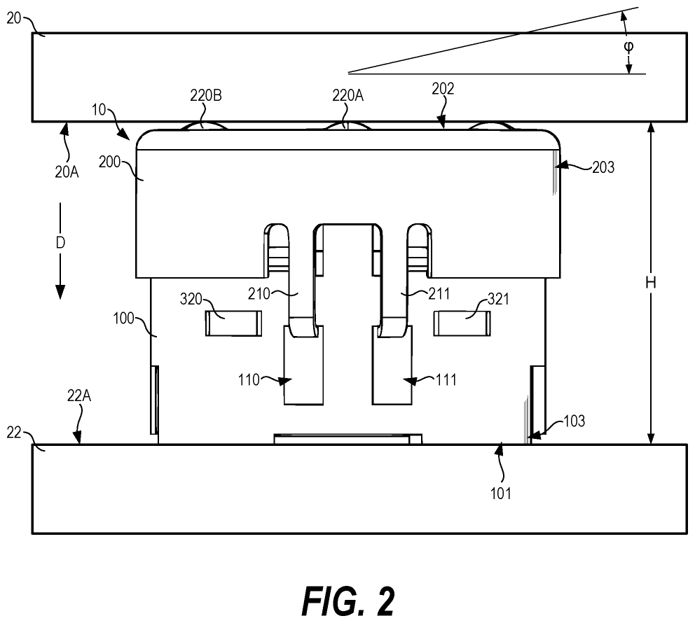

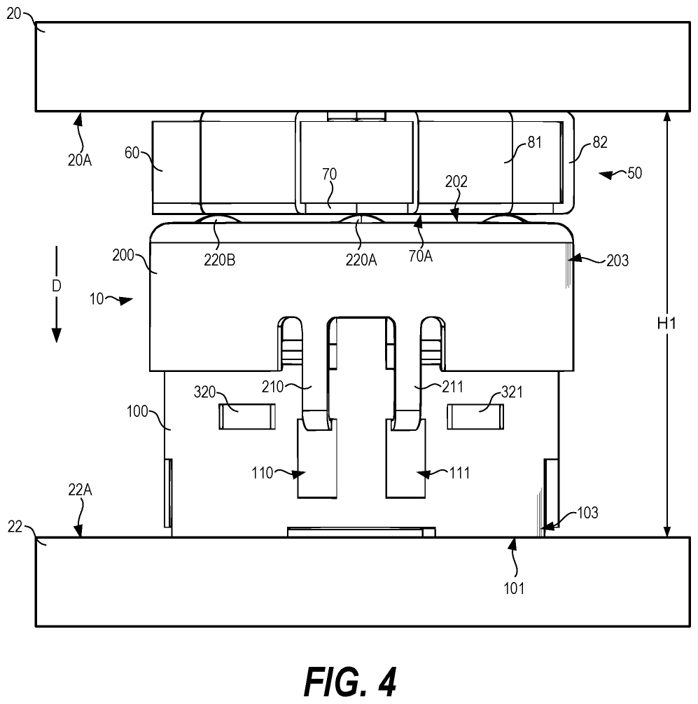

A second PCB can be brought into position and contact with a top surface 202 of the shield lid 200. The second PCB can also apply a downward pressure or force upon the top surface 202 of the lid 200 in the direction “D,” pushing the lid 200 down in the direction “D” against the spring bias of the interface contactor 10. Conductive traces or pads of the second PCB can make electrical contact with the top surface 202 of the shield lid 200. Other conductive traces or pads of the second PCB can make electrical contact with a top of the conductive pin 350. An additional example of the placement and coupling of the interface contactor 10 between two PCBs is described below with reference to FIGS. 2 and 4.

The housing 100 and the lid 200 can be formed from an electrically-conductive, metallic material, such as brass, copper, gold, silver, or other conductive metals or alloys thereof. In one example, the housing 100 and the lid 200 can be stamped or sheared out from a sheet of the electrically-conductive, metallic material, and then be bent or otherwise formed into the shape shown in FIG. 1A. The conductive pin 350 can also be formed from an electrically-conductive, metallic material, such as brass, copper, gold, silver, or other conductive metals or alloys thereof. The insulating interposer 300 can be formed from an insulating material, such as a dielectric insulator. The insulating interposer 300 can be formed from a polymer, such as a plastic material, a glass fiber epoxy compound, Polytetrafluoroethylene (PTFE), polyimide, or other insulating material(s).

FIG. 1F illustrates a perspective view of the shield lid 200 of the interface contactor 10 shown in FIG. 1A, with the remaining components of the interface contactor 10 omitted from view. As shown in FIG. 1F, the lid 200 includes interlock arms 210-213. The interlock arms 210-213 are formed in and extend down from the bottom edge 201 of the lid 200. Each of the interlock arms 210-213 includes an interlock curl end at a distal end, as best shown in FIG. 1F. Particularly, the interlock arm 210 includes an interlock curl 210A, the interlock arm 211 includes an interlock curl 211A, the interlock arm 212 includes an interlock curl 212A, and the interlock arm 213 includes an interlock curl 213A. In other examples, the number, positions, sizes, and shapes of the interlock arms 210-213 can vary as compared to that shown.

FIG. 1G illustrates a perspective view of the shield body housing 100 of the interface contactor 10 shown in FIG. 1A, with the remaining components of the interface contactor 10 omitted from view. As shown in FIG. 1G, the housing 100 includes extension channels 110-113. The extension channels 110-113 are formed through the housing 100 and extend through the outer surface 103 to the inner surface 104 of the housing 100, between the bottom edge 101 and the top edge 102. The extension channels 110-113 are formed to have a longitudinal axis “L” extending perpendicular to the edges 101 and 102 of the housing 100. In other examples, the number, positions, sizes, and shapes of extension channels 110-113 can vary as compared to that shown.

The interlock arms 210-213 of the lid 200 fit and interlock into the extension channels 110-113 of the housing 100, respectively, when the interface contactor 10 is assembled. As shown in FIG. 1A, for example, the interlock arms 210 and 211 fit and interlock into the extension channels 110 and 111, with the interlock curls 210A and 211A extending into the extension channels 110 and 111. The interlock curls 210A-213A of the interlock arms 210-213 are thus mechanically seated within the extension channels 110-113. A mechanical interference between the edges of the interlock curls 210A-213A and the edges of the extension channels 110-113 maintains the lid 200 in position over the housing 100. That is, the mechanical interference prevents the shield lid 200 from rotating with respect to the housing 100, beyond a nominal clearance between the interlock curls 210A-213A and the extension channels 110-113. However, the shield lid 200 can still move in the direction “D” shown in FIG. 1A, as the interlock curls 210A-213A can shift or slide along the lengths of the extension channels 110-113. The lengths of the interlock arms 210-213 and the extension channels 110-113 can vary as compared to that shown in FIGS. 1A, 1F, and 1G, to determine or set the range of movement or travel between the lid 200 and the housing 100.

Referring to FIG. 1G, the housing 100 also includes interlock apertures 120-123. The interlock apertures 120-123 are formed through the housing 100 and extend through the outer surface 103 to the inner surface 104 of the housing 100. The interlock apertures 120-123 are formed to help position and interlock the insulating interposer 300 within the housing 100, as described in further detail below. The housing 100 also includes interlock cutouts 130 and 131. The interlock cutouts 130 and 131 are formed as cutouts from the bottom edge 101 of the housing 100. The interlock cutouts 130 and 131 are formed to help position and interlock the insulating interposer 300 within the housing 100, as described in further detail below. In other examples, the number, sizes, shapes, and positions of the interlock apertures 120-123 and the interlock cutouts 130 and 131 can vary as compared to that shown.

FIG. 1H illustrates a perspective view of the interface contactor 10 shown in FIG. 1A, with the shield lid 200 omitted from view. The housing 100 includes spring contact arms 140 and 141, as shown in FIG. 1H. The spring contact arms 140 and 141 are integrally formed as part of the housing 100. The spring contact arms 140 and 141 extend up and over the top edge 102 of the housing 100. The spring contact arms 140 and 141 also extend up and bend over a central region of the housing 100. The spring contact arms 140 and 141 are each formed in a semi-circular “C” shape, opposing each other. Together, the spring contact arms 140 and 141 form a type of ring that extends over a top surface 302 of the insulating interposer 300 and around the conductive pin 350. The spring contact arms 140 and 141 are illustrated as a representative example in FIG. 1H. In other examples, the spring contact arms 140 and 141 can vary in size and shape as compared to that shown. For example, the spring contact arms 140 and 141 can be smaller or have shorter arms. Another example of spring contact arms is illustrated in FIG. 5A and described below.

The spring contact arm 140 includes contact arm bends 150 and 151. The contact arm bends 150 and 151 are positioned at the distal ends of the spring contact arm 140. Similarly, the spring contact arm 141 includes contact arm bends 152 and 153. The contact arm bends 152 and 153 are positioned at the distal ends of the spring contact arm 141. When the shield lid 200 is positioned over the housing 100, the under surface 205 (see FIG. 1F) of the lid 200 contacts the top surfaces of the contact arm bends 150-153. The contact arm bends 150-153 thus support the shield lid 200 over the housing 100.

The spring contact arms 140 and 141 are flexible and act as springs. Particularly, the spring contact arm 140 can bend or rotate in the direction “R” shown in FIG. 1H, based on a downward force applied. Similarly, the spring contact arm 141 can bend or rotate in a similar way based on a downward force applied. Thus, the spring contact arms 140 and 141 provide a type of spring bias against the lid 200, when the lid 200 is positioned over the housing 100. When a downward force is applied to the lid 200, the force is translated to the spring contact arms 140 and 141, and the spring contact arms 140 and 141 can bend or rotate down, providing a spring bias for the interface contactor 10. As such, the interface contactor 10 is compressible to some extent, with the lid 200 capable of being pressed down over the housing 100.

FIG. 1I illustrates a perspective view of the conductive pin 350 and the insulating interposer 300 of the interface contactor 10 shown in FIG. 1A, with the housing 100 and the lid 200 omitted from view. The interposer 300 includes a bottom surface 301, a top surface 302, and outer surface 303, among other edges and surfaces. A central pin aperture extends through the interposer 300, and the conductive pin 350 extends through the pin aperture. The conductive pin 350 is press-biased. A compression member 400 (see FIGS. 1J and 1K) is positioned with the interposer 300, under the conductive pin 350, and the compression member 400 applies a compression bias against a bottom surface of the conductive pin 350, as described in further detail below.

The interposer 300 includes interlock extensions 320-332, among potentially others, which extend out and beyond from the outer surface 303 of the interposer 300. The interlock extensions 320-332 are seated and positioned into the interlock apertures 120-122 of the housing 100 when the interposer 300 is positioned within the housing 100. A mechanical interference between the edges of the interlock extensions 320-332 of the interposer 300 and the interlock apertures 120-122 of the housing 100 maintains the position of the interposer 300 within the housing 100. That is, the mechanical interference prevents the interposer 300 from moving or rotating with respect to the housing 100 when the interface contactor 10 is assembled.

The interposer 300 also includes the interlock extension 331 shown in FIG. 1I and another interlock extension on an opposite side of the interposer, which is obscured from view in FIG. 1I. The interlock extension 331 is seated and positioned into the interlock cutout 131 of the housing 100, when the interposer 300 is positioned within the housing 100. A mechanical interference between the edges of the interlock extension 331 of the interposer 300 and the interlock cutout 131 of the housing 100 maintains the position of the interposer 300.

FIG. 1J illustrates a perspective view of the press-biased conductive pin 350 and the compression member 400 of the interface contactor 10 shown in FIG. 1A. FIG. 1K illustrates a perspective view of the compression member 400. As shown in FIG. 1J, the press-biased conductive pin 350 includes a seating platform 360 at one end. The circumference of the seating platform 360 is larger than the circumference of the remainder of the conductive pin 350. Above the seating platform 360, the conductive pin 350 is cylindrical in shape and includes a semi-spherical head at the end opposite from the seating platform 360. A bottom surface 361 of the seating platform 360 rests upon the compression member 400. Both the conductive pin 350 and the compression member 400 are electrically conductive and provide a conductive path for the electrical transmission of an RF or data signal through the interface contactor 10. As noted above, the conductive pin 350 and the compression member 400 are electrically isolated from the housing 100 and the lid 200, and the interposer 300 maintains electrical isolation between them.

Referring to FIG. 1K, the compression member 400 includes a base plate 410, a compression arm 420 extending up from an end edge of the base plate 410, and a number of base arms 430-432 extending from side edges of the base plate 410. The compression arm 420 curls up from and over the base plate 410. The compression arm 420 includes a contact bend 440 at one end. The bottom surface 361 the conductive pin 350 rests upon a top surface of the contact bend 440 when the interface contactor 10 is assembled. The compression arm 420 is flexible and can bend over the base plate 410. The compression arm 420 thus applies a compression bias (i.e., upward force) against the bottom surface 361 of the conductive pin 350. A downward force applied to the conductive pin 350 can overcome the bias and compress the compression arm 420 down toward the base plate 410.

The compression member 400 can be formed from an electrically-conductive, metallic material, such as brass, copper, gold, silver, or other conductive metals or alloys thereof. In one example, the compression member 400 can be stamped or sheared out from a sheet of the electrically-conductive, metallic material, and then be bent or otherwise formed into the shape shown in FIG. 1K. Because the compression member 400 is conductive, electrical signals can pass from the compression member 400 to the conductive pin 350.

A bottom-up view of the interface contactor 10 is shown in FIG. 1E. In that view, a bottom of the compression member 400 is shown. The compression member 400 is positioned within a pin cavity 330 formed within the insulating interposer 300. The bottom surface 361 of the conductive pin 350 is also visible in FIG. 1E. The bottom of the compression member 400 can be electrically coupled (e.g., soldered, sintered, etc.) to conductive traces or pads of a PCB, to form an electrical connection to the compression member 400 and the conductive pin 350.

FIG. 1L illustrates the cross-sectional view of the interface contactor 10 designated A-A in FIG. 1A. The arrangement of the interposer 300, the conductive pin 350, and the compression member 400, within the interface contactor 10, is visible in FIG. 1L. The interposer 300 is seated and positioned within the housing 100, and the conductive pin 350 and the compression member 400 are positioned within the pin cavity 330 formed within the insulating interposer 300. The contact bend 440 of the compression arm 420 of the compression member 400 contacts and applies a compression bias against the bottom surface 361 of the conductive pin 350, holding the conductive pin 350 in place. The top of the seating platform 360 is pushed against the lower surface 335 of the pin cavity 330 in this arrangement. However, a downward force applied to the conductive pin 350 can overcome the bias provided by the compression arm 420, so that the conductive pin 350 can be pushed down further in the pin cavity 330 formed within the insulating interposer 300. Thus, the interface contactor 10 is compressible to some extent. The lid 200 can be pushed or compressed down against the spring bias provided by the spring contact arms 140 and 141. Additionally and separately, the conductive pin 350 can be pushed or compressed down against the compression bias provided by the compression member 400.

FIG. 2 illustrates an example of the interface contactor 10 placed between two PCBs 20 and 22 according to various embodiments of the present disclosure. The PCBs 20 and 22 can be arranged together in a housing of device and secured separately therein, with the interface contactor 10 positioned between them. The illustration in FIG. 2 is representative and provided to convey the concepts of the low profile board-to-board interface contactors or connectors described herein. Although only one interface contactor is shown in FIG. 2, any number of interface contactors can be positioned between the PCBs 20 and 22 or other PCBs according to the embodiments, so that any number of different signals can be coupled between them.

The interface contactor 10, among possibly others, can be relied upon to electrically couple signals between the two PCBs 20 and 22. To that end, the interface contactor 10 can be positioned between the planar surfaces of the PCBs 20 and 22 to form electrical couplings between them. In one example, the bottom edge 101 of the housing 100 can be mounted and electrically coupled (e.g., soldered, sintered, etc.) to conductive traces or pads on an upper surface 22A on the PCB 22, to form a common or drain coupling between the PCB 22 and the housing 100. The bottom surface of the compression member 400 (see FIGS. 1J and 1K and description below) can also be electrically coupled (e.g., soldered, sintered, etc.) to other conductive traces or pads on the upper surface 22A of the PCB 22, to form an electrical signal coupling between the PCB 22 and the conductive pin 350.

The PCB 20 can be brought into position and contact with the top surface 202 of the lid 200, so that the lower surface 20A of the PCB 20 contacts the top surface 202. Particularly, the contact bumps 220A-220C, among others, of the shield lid 200 can contact the lower surface 20A of the PCB 20. Based on the arrangement of the PCBs 20 and 22 (i.e., how closely they are mounted with respect to each other), the PCB 22 can also apply a downward pressure or force upon the top surface 202 of the lid 200 in the direction “D,” pushing the lid 200 down in the direction “D” against the spring bias of the interface contactor 10. Conductive traces or pads of the PCB 22 can make electrical contact with the top surface 202 of the shield lid 200. Other conductive traces or pads of the PCB 22 can make electrical contact with a top of the conductive pin 350.

The interface contactor 10 facilitates electrical connections between the PCBs 20 and 22, even if the PCBs 20 and 22 are not arranged to be parallel to each other. For example, the lid 200 of the interface contactor 10 can pivot or tilt to some extent with respect to the housing 100, if the PCBs 20 and 22 are not exactly parallel to each other. The angle φ in FIG. 2 is representative of an angle between the lower surface 20A of the PCB 20 and the upper surface 22A of the PCB 22, both of which are assumed to be planar. The interface contactor 10 can accommodate non-zero angles φ. For example, if the angle φ is one, two, or more degrees, the lid 200 of the interface contactor 10 can pivot or tilt to some extent with respect to the housing 100, to accommodate the angle φ. In various designs, the interface contactor 10 can accommodate angles φ of one, two, three, four, five, six, seven or more degrees, although larger angles can be accommodated in some cases.

In the arrangement shown in FIG. 2, a space or distance “H” extends between the lower surface 20A of the PCB 20 and the upper surface 22A of the PCB 22. The interface contactor 10 can be designed or sized to facilitate a range of spacings between the PCBs 20 and 22. The interface contactor 10 is generally designed to facilitate reduced dimensions in “H” as compared to other contactors or connectors that are currently available. An example range for “H” can be between 2.5 mm to 7.5 mm, although the interface contactor 10 can be designed to facilitate other spacings between PCBs. As examples, the interface contactor 10 can be designed or sized to facilitate spacings (e.g., dimensions “H”) of 2.5 mm, 3.0 mm, 3.5 mm, 4.0 mm, 5.0 mm, 6.0 mm, 6.5 mm, 7.0 mm, or 7.5 mm, although the interface contactor 10 is not limited to one or more of those sizes. It should be appreciated, in any case, that the interface contactor 10 is capable of accommodating a range of dimensions “H,” as the interface contactor 10 can be compressed over a range of “H.”

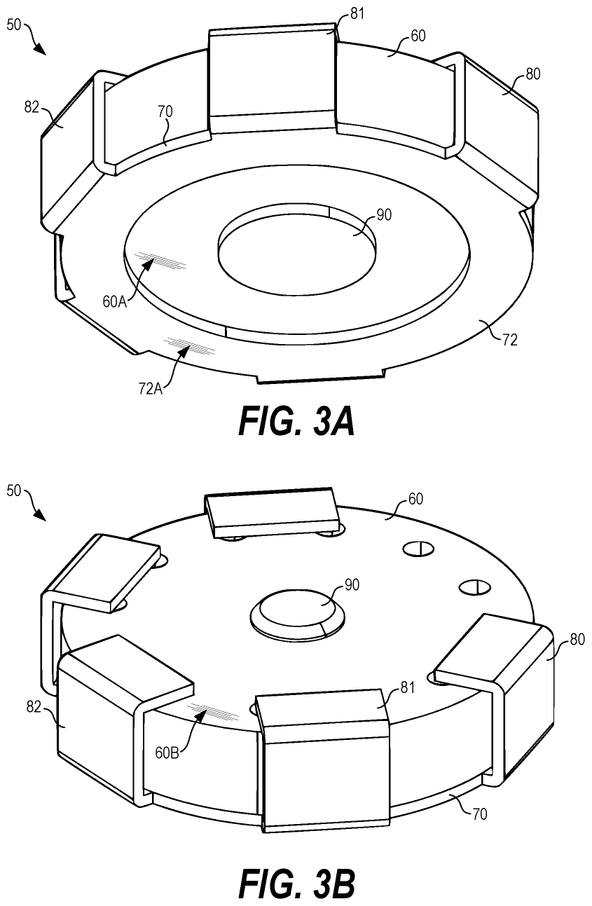

In the example shown in FIG. 2, the interface contactor 10 is positioned between the PCBs 20 and 22, without any additional components intervening or placed between them. However, in some cases, the interface contactor 10 can be positioned between PCBs along with other low profile interface contactor or connector components. FIG. 3A illustrates a bottom-up perspective view of a button contactor 50 according to various embodiments of the present disclosure, and FIG. 3B illustrates a top-down perspective view of the button contactor 50. The button contactor 50 is representative, not drawn to any particular scale, and is illustrated to provide context for the concepts of the low profile board-to-board interface contactors or connectors described herein. The button contactors described herein can be formed in a range of different shapes, styles, and sizes, although certain sizes and shapes are described and illustrated. The button contactors can also be used in a range of interconnect applications, although board-to-board interface applications are described in some examples.

The button contactor 50 includes an insulating button interposer 60 (also “interposer 60”), a shield ring housing 70 (also “ring housing 70”), and a button pin 90, among possibly other components. The ring housing 70 is formed around the interposer 60. The button pin 90 is positioned within the button contactor 50 and is centrally positioned to extend within the interposer 60. The button pin 90 is electrically isolated from the ring housing 70. The ring housing 70 extends around the interposer 60 and the button pin 90, to help shield the button pin 90 from electromagnetic interference. When used as a contactor or connector between PCBs, the ring housing 70 can be electrically coupled to ground, common, or drain contacts on the PCBs, and the button pin 90 can be electrically coupled to RF or data signal traces or conductive pads on the PCBs.

The ring housing 70 can be formed from an electrically-conductive, metallic material, such as brass, copper, gold, silver, or other conductive metals or alloys thereof. In one example, the ring housing 70 can be stamped or sheared out from a sheet of the electrically-conductive, metallic material, and then be bent or otherwise formed into the shape shown in FIGS. 3A and 3B. The button pin 90 can also be formed from an electrically-conductive, metallic material, such as brass, copper, gold, silver, or other conductive metals or alloys thereof. The interposer 60 can be formed from an insulating material, such as a dielectric insulator. The interposer 60 can be formed from a polymer, such as a plastic material, a glass fiber epoxy compound, Polytetrafluoroethylene (PTFE), polyimide, or other insulating material(s).

The ring housing 70 includes a ring 72 having a lower surface 72A and a number of ring housing arms, such as the arms 80-82, among others. The ring 72 is seated upon (i.e., contacts) the lower surface 60A of the interposer 60. The arms 80-82 extend from a side edge of the ring 72 and bend up and over the interposer 60, with the ends of the arms 80-82 being seated over and upon the upper surface 60B of the interposer 60. The number, positions, and spacings of the arms 80-82 can vary as compared to that shown in other examples.

The button contactor 50 can be relied upon to electrically couple an RF signal between PCBs, in one example, although button contactor 50 can couple other types of signals, including data signals, between PCBs. The button contactor 50 can be used in connection with the interface contactor 10, for example, to couple signals between PCBs. As one example, FIG. 4 illustrates the interface contactor 10 and the button contactor 50 positioned between the PCBs 20 and 22. The PCBs 20 and 22 can be arranged together in a housing of device and secured separately therein, with the interface contactor 10 and the button contactor 50 positioned between them. The illustration in FIG. 4 is representative and provided to convey the concepts of the low profile board-to-board interface contactors or connectors described herein. Although only one interface contactor and one button contactor are shown in FIG. 4, any number of interface contactors and button contactors can be positioned between the PCBs 20 and 22 or other PCBs according to the embodiments, so that any number of different signals can be coupled between them.

As shown in FIG. 4, the interface contactor 10 and the button contactor 50 can be positioned between the planar surfaces of the PCBs 20 and 22, in a stacked arrangement, to form electrical couplings between them. As shown in FIG. 4, the bottom edge 101 of the housing 100 can be mounted and electrically coupled (e.g., soldered, sintered, etc.) to conductive traces or pads on an upper surface 22A on the PCB 22, to form a ground, common, or drain coupling between the PCB 22 and the housing 100. The bottom surface of the compression member 400 (see FIGS. 1J and 1K and description below) can also be electrically coupled (e.g., soldered, sintered, etc.) to other conductive traces or pads on the upper surface 22A of the PCB 22, to form an electrical signal coupling between the first PCB and the conductive pin 350.

Additionally, the upper surfaces of the arms 80-82 (see FIG. 3B), among others, of the button contactor 50 can be mounted and electrically coupled (e.g., soldered, sintered, etc.) to conductive traces or pads on an upper surface 22A on the PCB 22, to form a ground, common, or drain coupling between the PCB 22 and the ring housing 70 of the button contactor 50. An upper surface of the button pin 90 (see FIG. 3B) can also be electrically coupled (e.g., soldered, sintered, etc.) to other conductive traces or pads on the upper surface 22A of the PCB 22, to form an electrical signal coupling between the PCB 22 and the button pin 90.

The PCB 20 with the button contactor 50 and the PCB 22 with the interface contactor 10 can be brought into position with each other as shown in FIG. 4. In the arrangement shown, the lower surface 72A of the ring 72 of the button contactor 50 contacts the top surface 202 of the interface contactor 10, to form a first electrical connection between them. Particularly, the lower surface 72A of the ring 72 contacts the contact bumps 220A-220C, among others, of the shield lid 200. Additionally, although not visible in FIG. 4, the end of the conductive pin 350 of the interface contactor 10 also contacts the button pin 90 of the button contactor 50, to form a second electrical connection between them. The first electrical connection can be a ground, common, or drain coupling, and the second electrical connection can be a signal coupling for an RF or data signal, in one example.

Based on the arrangement shown in FIG. 4, the PCB 22 and button contactor 50 can apply a downward pressure or force upon the top surface 202 of the lid 200 of the interface contactor 10 in the direction “D,” pushing the lid 200 down in the direction “D” against the spring bias of the interface contactor 10. Additionally, the lower surface 20A of the PCB 20 and the upper surface 22A of the PCB 22 are arranged with a distance “H1” between them. The interface contactor 10 and the button contactor 50 can be designed or sized facilitate a range of distances or spacings “H1”. The interface contactor 10 and the button contactor 50 are generally designed to facilitate reduced dimensions in “H1” as compared to other contactors or connectors that are currently available. Example dimensions for “H1” can range from 2.5 mm to 7.5 mm, although the contactors 10 and 50 can be designed to facilitate other spacings dimensions. As examples, the contactors 10 and 50 can be designed or sized to facilitate dimensions “H1” of 2.5 mm, 3.0 mm, 3.5 mm, 4.0 mm, 5.0 mm, 6.0 mm, 6.5 mm, 7.0 mm, or 7.5 mm, although other dimensions are within the scope of the embodiments. It should be appreciated, in any case, that the contactors 10 and 50 are capable of accommodating a range of dimensions “H1,” as the interface contactor 10 can be compressed over a range of “H1.”

Turning to other examples, FIG. 5A illustrates a perspective view of another example board-to-board interface contactor 500 (also “interface contactor 500”). FIG. 5B illustrates a perspective view of the interposers 600 and 650 and the conductive pin 700 of the board-to-board interface contactor 500 shown in FIG. 5A. FIG. 5C illustrates a perspective view of the conductive pin 700 and the compression member 750 of the board-to-board interface contactor 500 shown in FIG. 5A. The interface contactor 500 is representative and not drawn to any particular scale.

The interface contactor 500 can be relied upon as a type of low profile board-to-board interface contactor for electrically coupling an RF signal, for example, between two different PCBs. The interface contactor 500 includes a shield body housing 510 (also “housing 510”), insulating interposers 600 and 650 (also “interposers 600 and 650,” “interposer 600,” and “interposer 650”), and a press-biased conductive pin 700 (also “conductive pin 700”), among other components. The interface contactor 500 does not include a shield lid in the example shown. However, the interface contactor 500 can be used with a shield lid in some cases, similar to the shield lid 200 of the interface contactor 10 in other examples.

The shield body housing 510 includes a bottom edge 501, a top edge 502, and an outer surface 503, among other edges and surfaces. The outer surface 503 is cylindrical in shape, in the example shown. The housing 510 also includes spring contact arms 520-522, as shown in FIG. 5A. The spring contact arms 520-522 are integrally formed as part of the housing 510 and extend up and over the top edge 502 of the housing 510. The spring contact arms 520-522 also extend up and bend over a central region of the housing 510. The spring contact arms 520-522 are each formed in a semi-circular “L” shape and extend circularly around the conductive pin 700. The spring contact arms 520-522 can bend down and provide a type of spring bias. Thus, similar to the interface contactor 10, the interface contactor 500 is compressible to some extent.

Together, the spring contact arms 520-522 form a type of ring that extends over the insulating interposer 600 and around the conductive pin 700. The spring contact arms 520-522 are illustrated as a representative example in FIG. 5A. In other examples, the spring contact arms 520-522 can vary in size and shape as compared to that shown. For example, the spring contact arms 520-522 can be smaller or shorter. The spring contact arms 520-522 include contact arm bends 520A-522A. The contact arm bends 520A-522A are positioned at the distal ends of the spring contact arms 520-522. The contact arm bends 520A-522A are formed to contact traces or pads on a PCB. Alternatively, the contact arm bends 520A-522A can contact the lower surface 72A of the ring housing 70 of the button contactor 50, if the interface contactor 500 is used with the button contactor 50.

The interposers 600 and 650 are positioned and secured within the shield body housing 510. The conductive pin 700 is centrally positioned within the interface contactor 500 and extends through a central aperture in the interposer 600. The conductive pin 700 is electrically isolated from the housing 510. The housing 510 extends around the conductive pin 700, to help shield the conductive pin 700 from electromagnetic interference. When electrically coupled as a connector or contactor between PCBs, the housing 510 can be electrically coupled to ground, common, or drain contacts on the PCBs, and the conductive pin 700 can be electrically coupled to RF or data signal traces or conductive pads on the PCBs.

The housing 510 can be formed from an electrically-conductive, metallic material, such as brass, copper, gold, silver, or other conductive metals or alloys thereof. In one example, the housing 510 can be stamped or sheared out from a sheet of the electrically-conductive, metallic material, and then be bent or otherwise formed into the shape shown in FIG. 5A. The conductive pin 700 can also be formed from an electrically-conductive, metallic material, such as brass, copper, gold, silver, or other conductive metals or alloys thereof. The interposers 600 and 650 can be formed from an insulating material, such as a dielectric insulator. The interposers 600 and 650 can be formed from a polymer, such as a plastic material, a glass fiber epoxy compound, Polytetrafluoroethylene (PTFE), polyimide, or other insulating material(s).

The interface contactor 500 can be positioned between PCBs, as a type of contactor or connector between them, to form electrical couplings between them. In one example, the bottom edge 501 of the housing 510 can be mounted and electrically coupled (e.g., soldered, sintered, etc.) to conductive traces or pads of a first PCB, to form a common or drain coupling between the first PCB and the housing 510. An electrically-conductive compression member 750 (see FIGS. 5B and 5C and description below) of the interface contactor 500, which is electrically coupled to the conductive pin 700, can also be electrically coupled (e.g., soldered, sintered, etc.) to other conductive traces or pads of the first PCB, to form an electrical signal coupling between the first PCB and the conductive pin 700.

A second PCB can be brought into position and contact with the contact arm bends 520A-522A of the housing 510. The second PCB can also apply a downward pressure or force upon the spring contact arms 520-522, pushing the spring contact arms 520-522 down against the spring bias provided by the spring contact arms 520-522. The spring contact arms 520-522 can be electrically coupled to (e.g., physically contacted with) conductive traces or pads of the second PCB, to form a ground, common, or drain coupling between the second PCB and the housing 510. The conductive pin 700 can also be electrically coupled to (e.g., physically contacted with) other conductive traces or pads of the second PCB, to form an electrical signal coupling between the second PCB and the conductive pin 700.

FIG. 5B illustrates a perspective view of the conductive pin 700, the insulating interposers 600 and 650, and the compression member 750 of the interface contactor 500, with the housing 510 omitted from view. The interposers 600 and 650 are separate from each other, and the interposer 600 is positioned above the interposer 650 within the housing 510. A central pin aperture extends through the interposer 600, and the conductive pin 700 extends through the pin aperture. The compression member 750 is positioned within a cavity 655 formed in the interposer 650. The conductive pin 700 is press-biased. Particularly, the conductive pin 700 sits upon and is supported by the compression member 750, and the compression member 750 applies a compression bias against a bottom surface of the conductive pin 700.

The interposer 600 includes interlock extensions, such as the interlock extension 611, among others. The interlock extension 611 extends out and beyond from the outer surface of the interposer 600. The interlock extension 611 is seated and positioned into an interlock aperture of the housing 510, as shown in FIG. 5A, when the interposer 600 is positioned within the housing 510. A mechanical interference between the edges of the interlock extension 611 and the interlock aperture of the housing 510 maintains the position of the interposer 600 within the housing 510. That is, the mechanical interference prevents the interposer 600 from moving or rotating with respect to the housing 510 when the interface contactor 500 is assembled.

The interposer 650 also includes interlock extensions, such as the interlock extension 651, among others. The interlock extension 651 extends out and beyond from the outer surface of the interposer 650. The interlock extension 651 is seated and positioned into another interlock aperture of the housing 510, as shown in FIG. 5A, when the interposer 650 is positioned within the housing 510. A mechanical interference between the edges of the interlock extension 651 and the interlock aperture of the housing 510 maintains the position of the interposer 650 within the housing 510. That is, the mechanical interference prevents the interposer 650 from moving or rotating with respect to the housing 510 when the interface contactor 500 is assembled.

FIG. 5C illustrates a perspective view of the press-biased conductive pin 700 and the compression member 750 of the interface contactor 500. The press-biased conductive pin 700 includes a seating barrel 710 at one end. The circumference of the seating barrel 710 is larger than the circumference of the remainder of the conductive pin 700. Above the seating barrel 710, the conductive pin 700 is cylindrical in shape and includes a semi-spherical head at the end opposite from the seating barrel 710. A bottom surface of the seating barrel 710 rests upon the compression member 750. Both the conductive pin 700 and the compression member 750 are electrically conductive and provide a conductive path for the electrical transmission of an RF or data signal through the interface contactor 500. As noted above, the conductive pin 700 and the compression member 750 are electrically isolated from the housing 510, and the interposers 600 and 650 maintain electrical isolation between them.

The compression member 750 includes a base plate 752, a compression arm 754 extending up from an end edge of the base plate 752, and a number of base arms 758 extending from another end edge of the base plate 752. The compression arm 754 curls up and over the base plate 752. The compression arm 754 includes a contact bend 756. The bottom surface the conductive pin 700 rests upon a top surface of the contact bend 756, when the interface contactor 500 is assembled. The compression arm 754 is flexible and can bend over the base plate 752. The compression arm 754 thus applies a compression bias (i.e., upward force) against the bottom surface of the conductive pin 700. A downward force applied to the conductive pin 700 can overcome the bias and compress the compression arm 754 down toward the base plate 752.

The compression member 740 can be formed from an electrically-conductive, metallic material, such as brass, copper, gold, silver, or other conductive metals or alloys thereof. In one example, the compression member 740 can be stamped or sheared out from a sheet of the electrically-conductive, metallic material, and then be bent or otherwise formed into the shape shown in FIG. 5C. Because the compression member 750 is conductive, electrical signals can pass from the compression member 750 to the conductive pin 700.

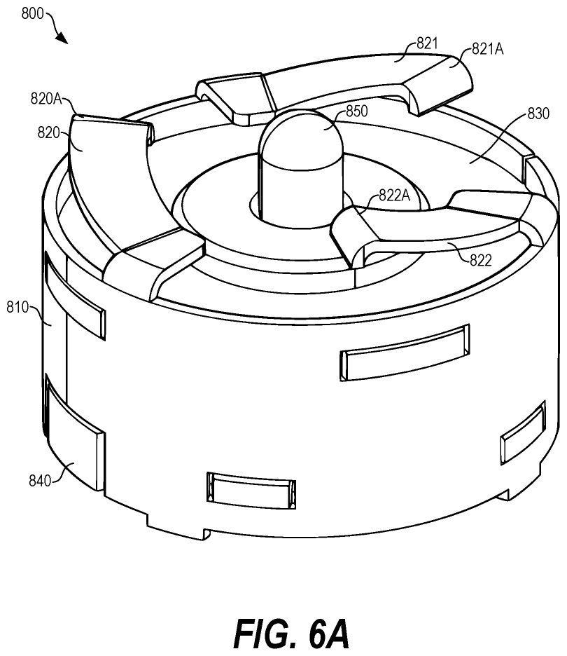

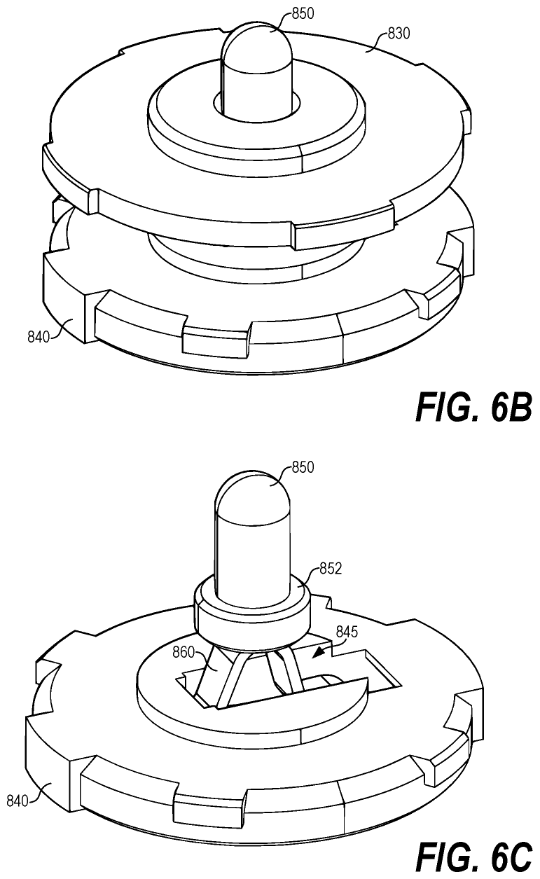

The interface contactor 500 shown in FIG. 5A can also be varied in size, and particularly height, to accommodate a range of spacings between PCBs. For example, FIG. 6A illustrates a perspective view of another example board-to-board interface contactor 800 (also “interface contactor 800”). FIG. 6B illustrates a perspective view of the interposers 830 and 840 and the conductive pin 850 of the interface contactor 800, and FIG. 5C illustrates a perspective view of the conductive pin 850 and the compression member 860 of the interface contactor 800.

The interface contactor 800 includes a shield body housing 810 (also “housing 810”), insulating interposers 830 and 840, and a press-biased conductive pin 850, among other components. The interface contactor 800 does not include a shield lid in the example shown. However, the interface contactor 800 can be used with a shield lid in some cases, similar to the shield lid 200 of the interface contactor 10 in other examples.

The housing 810 includes spring contact arms 820-822. The spring contact arms 820-822 are integrally formed as part of the housing 810 and extend up and over the top of the housing 810. The spring contact arms 820-822 are each formed in a semi-circular “L” shape and extend circularly around the conductive pin 850. Together, the spring contact arms 820-822 form a type of ring that extends over the insulating interposer 830 and around the conductive pin 850. The spring contact arms 820-822 include contact arm bends 820A-822A. The contact arm bends 820A-822A are positioned at the distal ends of the spring contact arms 820-822. The contact arm bends 820A-822A are formed to contact traces or pads on a PCB. Alternatively, the contact arm bends 820A-822A can contact the lower surface 72A of the ring housing 70 of the button contactor 50, if the interface contactor 800 is used with the button contactor 50.

The interposers 830 and 840 are positioned and secured within the shield body housing 810. The conductive pin 850 is centrally positioned within the interface contactor 800 and extends through a central aperture in the interposer 830. The conductive pin 850 is electrically isolated from the housing 810. The housing 810 extends around the conductive pin 850 to help shield the conductive pin 850 from electromagnetic interference.

FIG. 6B illustrates a perspective view of the conductive pin 850 and the insulating interposers 830 and 840, with the housing 810 omitted from view. The interposers 830 and 840 are separate from each other, and the interposer 830 is positioned above the interposer 840 within the housing 810. A central pin aperture extends through the interposer 830, and the conductive pin 850 extends through the pin aperture.

FIG. 6C illustrates a perspective view of the conductive pin 850, the interposer 840, and the compression member 860 of the interface contactor 800. The conductive pin 850 includes a seating barrel 852 at one end. The circumference of the seating barrel 852 is larger than the circumference of the remainder of the conductive pin 850. Above the seating barrel 852, the conductive pin 850 is cylindrical in shape and includes a semi-spherical head at the end opposite from the seating barrel 852. A bottom surface of the seating barrel 852 rests upon the compression member 860. Both the conductive pin 850 and the compression member 860 are electrically conductive and provide a conductive path for the electrical transmission of an RF or data signal through the interface contactor 800. As noted above, the conductive pin 850 and the compression member 860 are electrically isolated from the housing 810, and the interposers 830 and 840 maintain electrical isolation between them. The compression member 860 is similar to the compression member 750 shown in FIG. 5C. A downward force applied to the conductive pin 850 can overcome the spring bias provided by the compression member 860.

The interface contactor 500 shown in FIG. 5A is taller than the interface contactor 800 shown in FIG. 6A. More particularly, the distance between the bottom edge 501 and the top edge 502 of the housing 510 is larger than that of the housing 810. As such, the interface contactor 500 shown in FIG. 5A is designed to accommodate larger spacings between PCBs, and the interface contactor 800 is designed to accommodate smaller spacings. Additionally, the interposers 600 and 650 in the interface contactor 500 are positioned or spaced further apart than the interposers 830 and 840 in the interface contactor 800. The conductive pin 700 in the interface contactor 500 is also longer than the conductive pin 850 in the interface contactor 800.

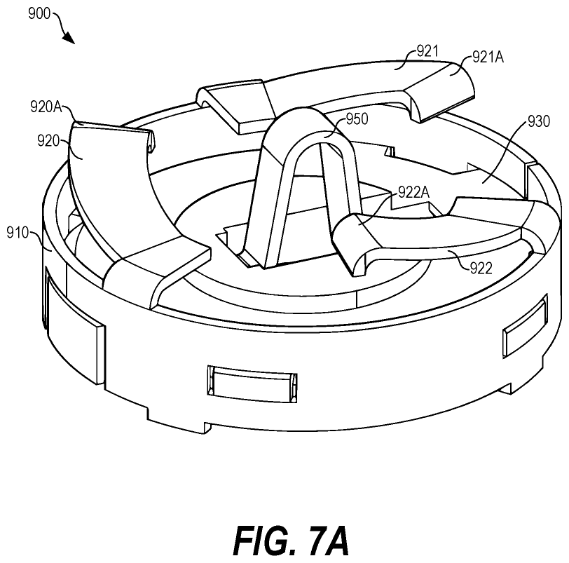

In another example, FIG. 7A illustrates a perspective view of a board-to-board interface contactor 900 (also “interface contactor 900”). The interface contactor 900 includes a shield body housing 910 (also “housing 910”), an insulating interposer 930, and a pin compression member 950. The interface contactor 900 does not include a shield lid in the example shown. However, the interface contactor 900 can be used with a shield lid in some cases.

The housing 910 includes spring contact arms 920-922. The spring contact arms 920-922 are integrally formed as part of the housing 910 and extend up and over the top of the housing 910. The spring contact arms 920-922 are each formed in a semi-circular “L” shape and extend circularly around the pin compression member 950. Together, the spring contact arms 920-922 form a type of ring that extends over the insulating interposer 930 and around the pin compression member 950. The spring contact arms 920-922 include contact arm bends 920A-922A. The contact arm bends 920A-922A are positioned at the distal ends of the spring contact arms 920-922. The contact arm bends 920A-922A are formed to contact traces or pads on a PCB. Alternatively, the contact arm bends 920A-922A can contact the lower surface 72A of the ring housing 70 of the button contactor 50, if the interface contactor 900 is used with the button contactor 50.

The interposer 930 is positioned and secured within the shield body housing 910. The pin compression member 950 is centrally positioned within the interface contactor 900 and is seated within the interposer 930. The pin compression member 950 is electrically isolated from the housing 910. The housing 910 extends around the pin compression member 950 to help shield the pin compression member 950 from electromagnetic interference. The pin compression member 950 is electrically conductive and provides a conductive path for the electrical transmission of an RF or data signal through the interface contactor 900. The pin compression member 950 is similar to the compression member 750 shown in FIG. 5C, but is taller. A downward force applied to the pin compression member 950 can overcome the spring bias it provides.

The interface contactor 900 shown in FIG. 7A is shorter or smaller than both the interface contactor 500 shown in FIG. 5A and the interface contactor 800 shown in FIG. 6A. As such, the interface contactor 900 shown in FIG. 7A is designed to accommodate smaller spacings between PCBs. Additionally, the interface contactor 900 includes only a single insulating interposer rather than two, and the interface contactor 900 does not include a conductive pin beyond the pin compression member 950.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

At least the following is claimed:

1. A board-to-board interface contactor, comprising:
a shield body housing, the shield body housing comprising a top edge, a bottom edge, and a spring contact arm;
a shield lid over the shield body housing, the shield lid being seated upon the spring contact arm of the shield body housing and comprising a central contactor opening;
an insulating interposer positioned within the shield body housing;
a press-biased conductive pin extending through an aperture in the insulating interposer; and
a compression member positioned with the insulating interposer, under the press-biased conductive pin, the compression member applying a compression bias against a bottom surface of the conductive pin.

2. The board-to-board interface contactor according to claim 1, wherein:
the spring contact arm comprises a plurality of contact arm bends; and
the shield lid is seated upon the contact arm bends of the spring contact arm.

3. The board-to-board interface contactor according to claim 1, wherein the spring contact arm extends from the top edge of the shield body housing.

4. The board-to-board interface contactor according to claim 1, wherein the spring contact arm comprises a plurality of spring contact arms.

5. The board-to-board interface contactor according to claim 4, wherein the plurality of spring contact arms extend in a ring around the press-biased conductive pin, over the insulating interposer.

6. The board-to-board interface contactor according to claim 1, wherein:
the insulating interposer comprises an interlock extension that extends beyond an outer cylindrical surface of the insulating interposer;
the shield body housing further comprises an interlock aperture; and
the interlock extension of the insulating interposer is positioned within the interlock aperture of the shield body housing, to maintain the position of the insulating interposer within the shield body housing.

7. The board-to-board interface contactor according to claim 1, wherein:
the shield lid further comprises an interlock arm;
the shield body housing further comprises an extension channel having a longitudinal axis that extends between the top edge and the bottom edge of the shield body housing; and
the interlock arm of the shield lid is positioned within the extension channel of the shield body housing.

8. A board-to-board interface contactor, comprising:
a shield body housing comprising a spring contact arm;
an insulating interposer positioned within the shield body housing; and
a conductive pin extending through an aperture in the insulating interposer.

9. The board-to-board interface contactor according to claim 8, further comprising:
a compression member positioned with the insulating interposer, under the conductive pin, the compression member applying a compression bias against a bottom surface of the conductive pin.

10. The board-to-board interface contactor according to claim 8, wherein:
the spring contact arm comprises a plurality of contact arm bends;
the board-to-board interface contactor further comprises a shield lid; and
the shield lid is seated upon the contact arm bends of the spring contact arm.

11. The board-to-board interface contactor according to claim 8, wherein the spring contact arm extends from a top edge of the shield body housing.

12. The board-to-board interface contactor according to claim 8, wherein the spring contact arm comprises a plurality of spring contact arms.

13. The board-to-board interface contactor according to claim 12, wherein the plurality of spring contact arms extend in a ring around the conductive pin, over the insulating interposer.

14. The board-to-board interface contactor according to claim 1, wherein:
the insulating interposer comprises an interlock extension that extends beyond an outer cylindrical surface of the insulating interposer;
the shield body housing further comprises an interlock aperture; and
the interlock extension of the insulating interposer is positioned within the interlock aperture of the shield body housing, to maintain the position of the insulating interposer within the shield body housing.

15. The board-to-board interface contactor according to claim 1, wherein:
the board-to-board interface contactor further comprises a shield lid with an interlock arm;
the shield body housing further comprises an extension channel; and
the interlock arm of the shield lid is positioned within the extension channel of the shield body housing.

16. A board-to-board interface system, comprising:
an interface contactor, comprising:
a shield body housing, the shield body housing comprising a top edge, a bottom edge, and a spring contact arm;
a shield lid over the shield body housing, the shield lid being seated upon the spring contact arm of the shield body housing and comprising a central contactor opening;
an insulating interposer within the shield body housing;
a press-biased conductive pin extending through an aperture in the insulating interposer; and
a compression member positioned with the insulating interposer, under the press-biased conductive pin, the compression member applying a compression bias against a bottom surface of the conductive pin; and
a button contactor, comprising:
an insulating button interposer; and
a shield ring housing that extends around the insulating button interposer.

17. The board-to-board interface system according to claim 16, further comprising:
a first printed circuit board and a second printed circuit board, wherein:
the first printed circuit board, the interface contactor, the button contactor, and the second printed circuit board are arranged in a stack, to electrically couple at least one signal from the first printed circuit board to the second printed circuit board through the interface contactor and the button contactor.

18. The board-to-board interface system according to claim 16, wherein the spring contact arm extends from a top edge of the shield body housing.

19. The board-to-board interface system according to claim 16, wherein:
the spring contact arm comprises a plurality of contact arm bends; and
the shield lid is seated upon the contact arm bends of the spring contact arm.

20. The board-to-board interface system according to claim 16, wherein:
the spring contact arm comprises a plurality of spring contact arms; and
the plurality of spring contact arms extend in a ring around the press-biased conductive pin, over the insulating interposer.
